(19) United States
(12) Patent Application Publication
(10) Pub. No.: US 2014/0036099 A1
(43) Pub. Date: Feb. 6, 2014

(54) Automated Scanning

(71) Applicant: Be Labs, LLC, Seattle, WA (US)

(72) Inventor: Edward Balassanian, Seattle, WA (US)

(73) Assignee: Be Labs, LLC, Seattle, WA (US)

(21) Appl. No.: 13/956,325

(22) Filed: Jul. 31, 2013

Related U.S. Application Data
(60) Provisional application No. 61/679,454, filed on Aug. 3, 2012.
(60) Provisional application No. 61/702,945, filed on Sep. 19, 2012.
(60) Provisional application No. 61/786,482, filed on Mar. 15, 2013.

(51) Int. Cl. G06F 3/00

(52) U.S. Cl. CPC G06F 3/005
USPC 348/207.1

(57) ABSTRACT

Techniques are disclosed relating to prediction of desired information types for image scanning In some embodiments, a scanner is configured to predict a desired information type based on applications (e.g., running on a device, displayed on a device, or recently opened on a device) and/or a coarse scan of an image to detect objects in a set of object types that include information types associated with running applications. Based on a predicted information type, in some embodiments, the scanner is configured to extract information from an image and automatically display the information to a user or send the information to an application. For example, in one embodiment, the scanner may automatically extract payment information from an image of a credit card and insert the information into payment fields on a merchant web site.

This application claims the benefit of U.S. Provisional Application No. 61/679,454, filed on Aug. 3, 2012, U.S. Provisional Application No. 61/702,945, filed on Sep. 19, 2012, and U.S. Provisional Application No. 61/786,482, filed on Mar. 15, 2013, which are incorporated by reference herein in their entirety.

### BACKGROUND

1. Technical Field

This disclosure relates to object recognition and image scanning.

2. Description of the Related Art

Computer image analysis may allow a user to determine objects captured by a camera and/or information associated with those objects. Traditional image analysis systems are often built for specific use cases and offer little flexibility. For example, security systems are typically configured to determine locations of individuals in particular monitored areas and/or recognize individuals. However, such a system may not be readily adapted to extract other types of information from images or video, e.g., in the context of a more generalized computing system. Further, more generalized systems may be complex and expensive because they often try to recognize objects among a large universe of objects without a sense of a smaller relevant set of objects for which to scan.

### SUMMARY

Techniques are disclosed relating to prediction of desired information types for image scanning In some embodiments, a scanner is configured to predict a desired information type based on applications (e.g., running on a device, displayed on a device, or recently opened on a device) and/or a coarse scan of an image to detect objects in a set of object types that include information types associated with running applications. Based on a predicted information type, in some embodiments, the scanner is configured to extract information from an image and automatically display the information to a user or send the information to an application. Applications may be associated with information types by indicating the information types, e.g., using an application programming interface (API) of the scanner, in some embodiments. Applications may also be associated with information types based on a list of known applications and associated information types, in some embodiments. Applications may be similarly associated with objects using an API or a list of objects associated with known applications, in some embodiments.

Based on a predicted or determined information type, in some embodiments, the scanner is configured to extract information from an image and automatically display the information to a user or send the information to an application. For example, in one embodiment, the scanner may automatically extract payment information from an image of a credit card and insert the information into payment fields on a merchant web site. In some embodiments, information types may include: payment information, contact information, text/document information, bill information, receipt information, image information (e.g., a photograph), drawing information, barcode information, etc.

### BRIEF DESCRIPTION OF THE DRAWINGS

FIG. 1 is a block diagram illustrating one exemplary embodiment of a device that includes a scanner.

FIG. 2 is a diagram illustrating various exemplary physical objects with various information types.

FIG. 3A is a flow diagram illustrating one embodiment of a method for extracting information from an image.

FIGS. 3B-3C are block diagrams illustrating exemplary inputs to scanner functionality.

FIG. 4 is a flow diagram illustrating another embodiment of a method for extracting information from an image.

FIG. 5 is a block diagram illustrating exemplary applications and associated information types and objects.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Various units, circuits, or other components may be described or claimed as “configured to” perform a task or tasks. In such contexts, “configured to” is used to connote structure by indicating that the units/circuits/components include structure (e.g., circuitry) that performs the task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. §112(f) for that unit/circuit/component.

### DETAILED DESCRIPTION

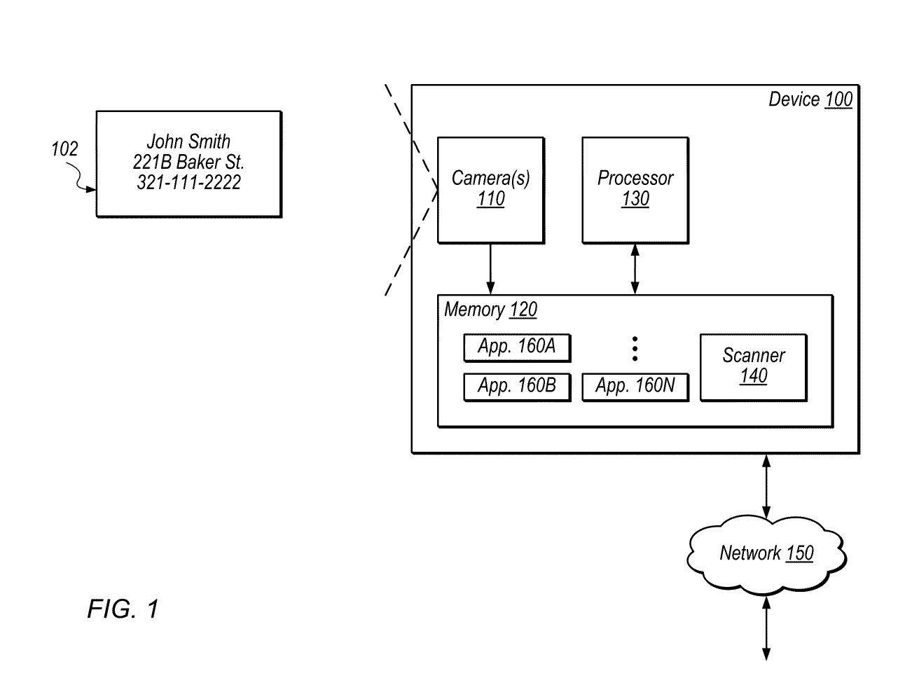

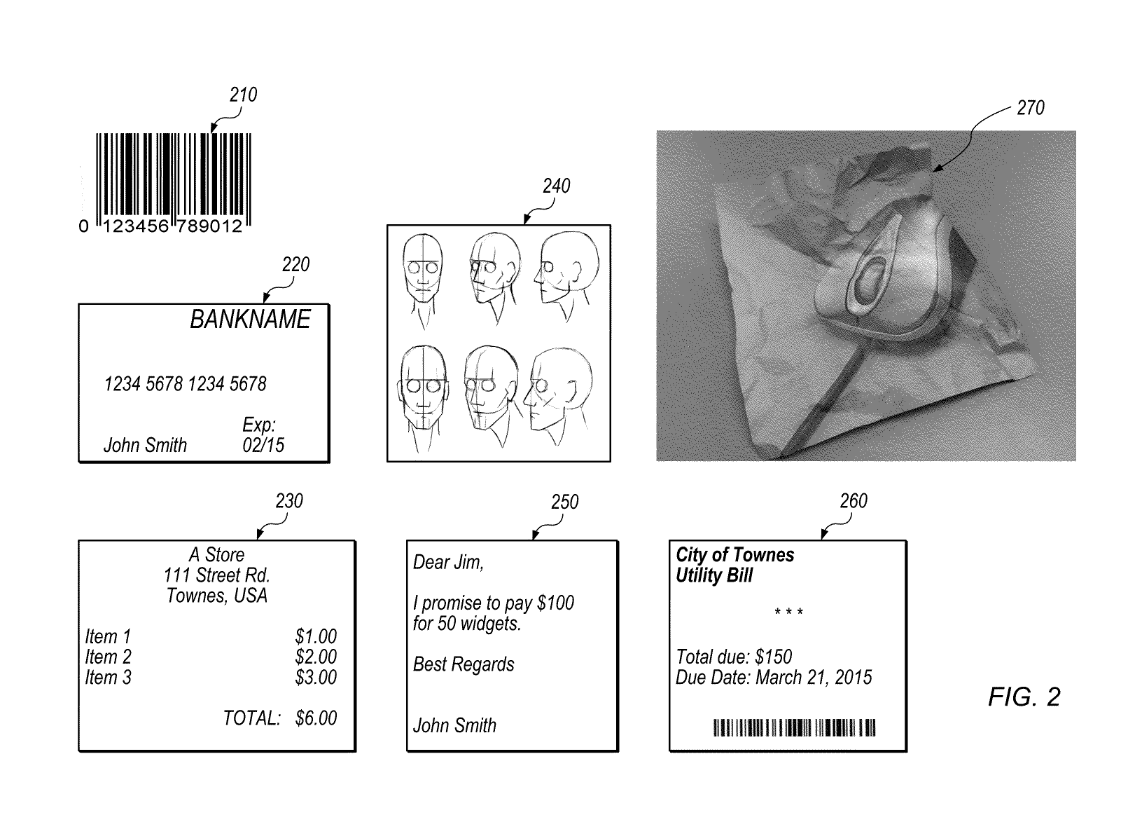

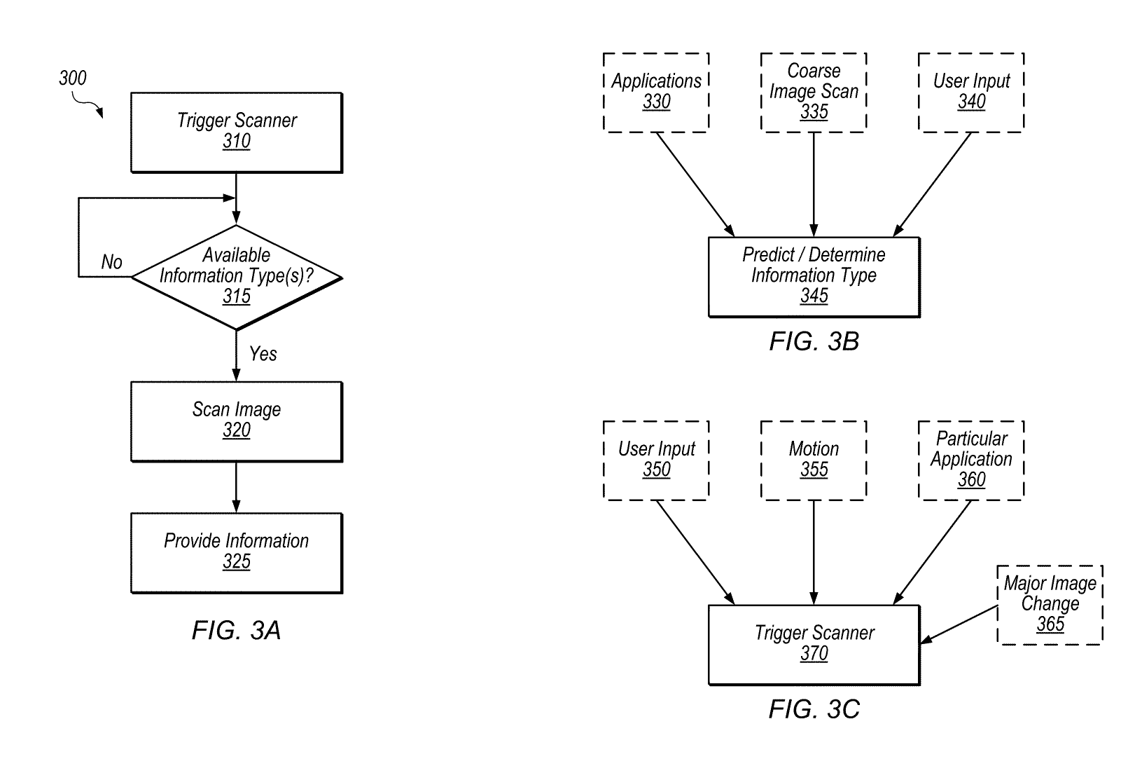

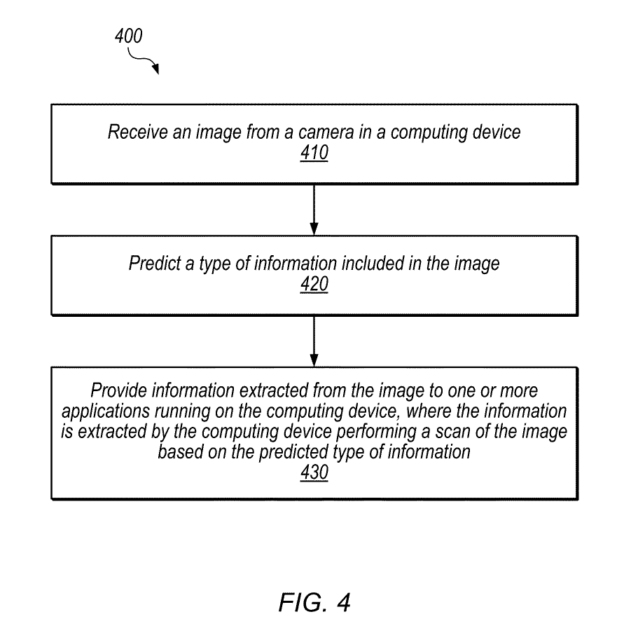

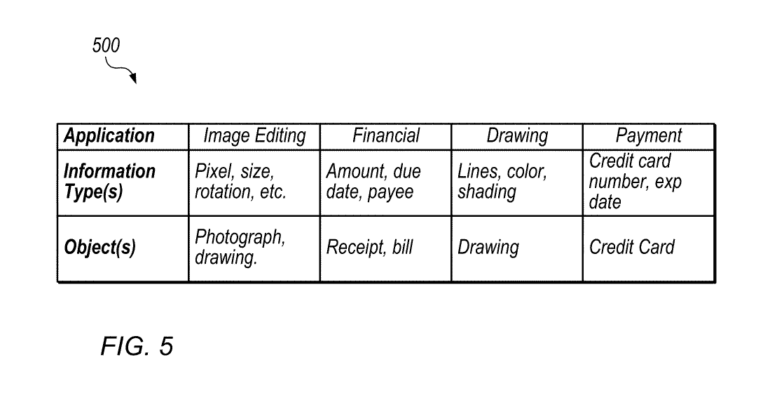

This disclosure initially describes, with reference to FIG. 1, an overview of an automated scanning system. It then describes exemplary information types with reference to FIG. 2 and embodiments of scanning methods with references to FIG. 3-4. FIG. 5 shows exemplary information types and objects associated with exemplary applications. In some embodiments, automated scanning may facilitate capturing and organizing various types of information using one or more cameras, without manual information entry by a user.

Referring to FIG. 1, a block diagram illustrating one embodiment of a device 100 configured to scan image data is shown. In the illustrated embodiment, device 100 includes camera(s) 110, memory 120, and processor 130 and is configured to communicate via network 150. In the illustrated embodiment, memory 120 stores applications 160A-N and scanner 140. In one embodiment, device 100 is a mobile computing device such as a mobile phone. In various embodiments, functions of device 100 described herein may be performed by hardware, software, firmware, or a combination thereof.

Camera(s) 110 may be referred to individually as a camera 110 and, in one embodiment, are configured to capture images as individual images and/or as video. For example, in the illustrated embodiment, camera 110 may capture an image that includes an object 102. In the illustrated embodiment, object 102 is a business card. In the illustrated embodiment, camera(s) 110 are configured to send image data to memory 120. In one embodiment, camera 110 may notify processor 130 when an image is captured. Camera 110 may be triggered by scanner 140 and/or applications 160, for example.

Processor 130, in the illustrated embodiment, is coupled to memory 120 and configured to execute program instructions of applications 160A-N and scanner 140. In various embodiments, processor 130 may include multiple processing cores and/or device 100 may include multiple processors.

Memory 120, in the illustrated embodiment, stores applications 160A-N, scanner 140 and/or image data from camera 110. Memory 120 may be implemented using any of various storage technologies and may be volatile or non-volatile in various embodiments. In some embodiments, device 100 may include multiple memories configured to store program instructions and/or image data.

Network 150, in some embodiments, may be a local area network (e.g., a WIFI network), a cellular network, etc. In some embodiments, network 150 may allow device 100 to communicate via the Internet. In some embodiments, device 100 may be connected to network 150 wirelessly. In some embodiments, device 100 is configured to perform various functionality described herein without being connected to, or configured to communicate with, network 150. In other embodiments, all or a portion of applications 160A-N and/or scanner 140 may be executed remotely, e.g., on a server (not shown) configured to communicate with device 100 via network 150.

Applications 160A-N, in the illustrated embodiment, include program instructions executable by processor 130 to perform various functionality. Applications 160 may be described as available or installed on device 100 whether or not they are currently executing instructions. Further, an application may be described as running or executing when processor 130 is executing instructions from the application. Applications may be described as running in the “background” when the applications are running but are not currently displayed. Scanner 140 may be configured to run in the background in various embodiments. An application may be described as “currently displayed” when graphics of the application are displayed on a significant portion display of device 100 (e.g., more than simply displaying an icon of an application is required for an application to be currently displayed). In some embodiments, multiple applications may be displayed at the same time using different portions of a display, for example. An application may be described as “recently opened” for a period of time after a user has launched the application, e.g., by selecting an icon of the application. The period of time may be different in different embodiments and may be user-configurable.

Scanner 140, in some embodiments, is configured to initiate image capture by camera(s) 110. In other embodiments, scanner 140 is not configured to initiate image capture, but is configured to receive captured image data. In various embodiments, scanner 140 includes program instructions that are executable to perform various operations based on running applications, captured image data, and/or user input. The operations may include sending information to appropriate applications, where the information is extracted from image data.

### Information Types

In some embodiments, scanner 140 is configured to determine that a user desires information from an image of a particular information type. In the illustrated example, object 102 includes contact information for John Smith, who resides at 221B Baker St. and whose telephone number is 321-111-2222. In one embodiment, scanner 140 is configured to automatically create or update a contact entry based on the contact information. For example, scanner 140 may be configured to search a user's address book and determine if a contact with the same name exists, and update the contact if so or create a new contact if not. In one embodiment, scanner 140 is configured to display an existing contact entry with the information if no new information is determined from the business card. Scanner 140 may be configured to determine a desired information type (e.g., contact information) in various different ways.

In some embodiments, scanner 140 is configured to determine or predict an information type based on currently running applications on device 100. In some embodiments, scanner 140 is configured to predict the information type without user input indicating the information type. For example, scanner 140 may determine that one or more running applications are associated with contact information (e.g., a user may be viewing contacts or checking email). In one embodiment, scanner 140 includes an application programming interface (API) that allows applications to indicate what information types they are associated with (e.g., information types that the applications utilize or operate on). In another embodiment, scanner 140 includes a list of known applications and information types associated with each application on the list. In this embodiment, scanner 140 may interact with applications without those applications being aware of scanner 140. As used herein, the term “predict” is used to refer to selection of an information type for a desired functionality of a user. For example, scanner 140 may be configured to predict a “payment” information type for the desired functionality of buying an item from a webpage. Because only the user may actually know the desired functionality, the prediction is not guaranteed to be correct without explicit user input indicating the desired information type. Therefore, a prediction may be a “guess” as to a desired information type. However, in some situations, the prediction may be near 100% accurate, e.g., based on applications running on a user device. This prediction may simplify image scanning and avoid a user having to explicitly indicate desired information types in various situations.

In one embodiment, scanner 140 is configured to determine an information type based on a currently displayed application on device 100. In some situations, device 100 may run multiple applications, but may display only one application to the user, for example. In one embodiment, scanner 140 is configured to determine an information type based on both a displayed application and on other running applications that are not displayed. Speaking generally, in some embodiments, scanner 140 is configured to select an information type from among multiple information types associated with running applications using a scoring system. In one embodiment, scanner 140 is configured to score applications differently based on whether they are currently opened. For example, scanner 140 may be configured to give greater weight to the currently displayed application than to the other applications when predicting an information type.

In one embodiment, scanner 140 is configured to score applications differently based on whether they are recently opened. In one embodiment, scanner 140 is configured to give greater weight to recently opened applications, e.g., for the first few seconds after a user opens an application. Opening an application may be an indication that the user is about to scan an object for an information type associated with the application. This may allow a user to open an application and then hold an object in front of a camera to be automatically scanned by scanner 140.

In some embodiments, scanner 140 is configured to determine an information type based on user input indicating the information type.

In some embodiments, scanner 140 is configured to determine an information type based on a coarse scan of image data. In one embodiment, scanner 140 is configured to determine a set of objects associated with applications running on device 100 (e.g., objects that include information associated with the applications). In this embodiment, scanner 140 is configured to perform a coarse scan of the image to search for objects in the set of objects. Searching for a relatively small set of known object types may greatly simplify complexity of image processing and may thus reduce processing time before automatically extracting information. In this embodiment, based on detecting an object in the set of objects, scanner 140 is configured to select an information type based on the object (e.g., selecting a contact information type based on detecting a business card). In one embodiment, scanner 140 is configured to select an information type from among multiple information types associated with applications running on device 100 based on detection of an object associated with the information type. In some embodiments, detecting an object may be based on formatting of information on the object. For example, a credit card may be detected based on typical dimensions as well as the formatting of a credit card number.

### Data Formats

In some embodiments, scanner 140 is configured to use different data formats for different applications and/or different information types. In one embodiment, scanner 140 provides an API that allows applications to indicate a desired data format for a given information type, and scanner 140 is configured to provide information to that application using the desired data format. In another embodiment, scanner 140 includes a list of applications and data formats associated with those applications for various information types. For example, scanner 140 may be configured to provide information to a web browser using a particular data format when entering payment information into payment fields of the web browser.

### Exemplary Object and Information Types

Referring now to FIG. 2, exemplary objects 210-270 that may be included in an image are shown. Objects 210-270 include a barcode, a credit card, a receipt, a text document with a signature field, a bill, a hand drawing, and a photograph. In some embodiments, scanner 140 may be configured to detect one or more of objects 210-270 and/or additional objects and extract information from the objects.

Barcode 210, in the illustrated embodiment, indicates the sequence of numbers “0123456789012.” Barcode 210 may be displayed on various surfaces such as a piece of paper, a box, a sign, etc. In one embodiment, scanner 140 may be configured to look up product information on the internet based on a barcode (e.g., a barcode representing a universal product code (UPC)) and provide the information to the user. In other embodiments, scanner 140 may be configured to determine information of various types from a barcode 210 and provide the information to one or more applications. As used herein, the term “barcode” refers to various machine-readable representations of data including using lines, dots, hexagons, squares, etc. to represent data.

In one embodiment, scanner 140 is configured to recognize barcodes during a coarse scan. In some embodiments, scanner 140 is configured to determine an information type represented by a barcode based on applications running and/or displayed on device 100 as discussed above.

In some embodiments, scanner 140 may be configured to find similar items to an item indicated by a barcode and display them to a user (e.g., along with pricing and review information). In various embodiments, scanner 140 may take any of various actions based on information encoded by barcodes. Barcodes may be included on other types of objects, such as the barcode shown on bill 260, for example. In some embodiments, scanner 140 may be configured to determine information from an object using both text and a barcode.

Credit card 220, in the illustrated embodiment, indicates a credit card number, a name (John Smith), and an expiration date (February 2015). Credit card 220 may also include a code number on the other side of the card. Credit card 220 is one example of an object that includes payment information.

In one embodiment, the user may use a web browser to navigate to a payment page on a website. In one embodiment, scanner 140 is configured to determine a payment situation based on text on a web page displayed in the web browser. In this embodiment, scanner 140 is configured to predict that a payment information type is desired based on the web browser being displayed on device 100. In another embodiment, the web browser is configured to explicitly indicate to scanner 140 that payment information is desired.

The user may hold a credit card up in front of camera 110 and scanner 140 may be configured to trigger based on a major change in images being captured by camera 110. In another embodiment, the user may press a button to trigger scanner 140. In yet another embodiment, scanner 140 may be configured to sense particular motions and may be triggered based on the user holding up the credit card, or performing a particular gesture with device 100. In some embodiments, scanner 140 is configured to automatically send payment information (e.g., to a web browser) extracted from image data (e.g., credit card number and expiration date). This may allow a user to make a payment without manually typing in payment information. In one embodiment, scanner 140 may be configured to store payment information for later use.

In one embodiment, after capturing information on the front of credit card 220, scanner 140 may be configured to prompt the user to turn the card around so that scanner 140 can capture additional information on the back of credit card 220.

Receipt 230, in the illustrated embodiment, indicates a store name and address, three items with corresponding prices, and a total. In one embodiment, scanner 140 is configured to enter information from a receipt into a spreadsheet or a financial application. In one embodiment, scanner 140 is configured to categorize the items, e.g., for organizing a budget. In one embodiment, scanner 140 is also configured to store images of receipts in analog format, e.g., without optical character recognition (OCR). In one embodiment, scanner 140 may determine that receipt information is desired based on a running financial application, for example.

Drawing 240, in the illustrated embodiment, is hand drawn and illustrates different views of a human head. Scanner 140 may be configured to determine various drawing information such as lines, text, shading, color, etc. In some embodiments, scanner 140 is configured to generate a digital drawing using computer drawing tools based on a presented drawing. For example, a user may create a drawing by hand or only have a hard copy of a drawing. The user may capture the drawing using camera 110, e.g., by holding the drawing up to the camera. In one embodiment, scanner 140 is configured to analyze the drawing, launch a drawing program (such as OMNIGRAFFLE® or VISIO®, for example) and recreate the drawing using drawing tools. In another embodiment, scanner 140 is configured to determine that drawing information is desired based on determining that a drawing program is currently running on device 100. In this embodiment, when a user holds a drawing in front of camera 110, scanner 140 is configured to translate the drawing into appropriate graphics, e.g., in the running OMNIGRAFFLE® application. In one embodiment, scanner 140 is configured to generate metadata in a data format recognized by the drawing program and send the metadata to the drawing program to allow the user to view the drawing in a given drawing program. The generated drawing may be user editable using the drawing program.

Document 250, in the illustrated embodiment, is an agreement that includes a signature field for John Smith. Other documents may include various fields or types of information that scanner 140 may be configured to recognize information such as formatting, font, etc. In one embodiment, scanner 140 is configured to automatically insert a digital signature (which may be previously configured by the user) into the blank signature field. In one embodiment, scanner 140 is configured to predict that text information is desired based on a text editing application running on device 100.

In one embodiment, scanner 140 is configured to use optical character recognition (OCR) to determine text information on document 250. In one embodiment, scanner 140 is configured to provide the text information to the text editing application, allowing the user to edit the document. In one embodiment, scanner 140 is configured to recognize a signature field on the sheet of paper and automatically insert a digital signature of a user into the signature field. In other embodiments, scanner 140 may be configured to recognize other types of fields in a document such as dates, locations, page numbers, etc. and mark those fields (e.g., by highlighting) or enter data into the fields (e.g., based on current date, location, etc.). In various embodiments, scanner 140 is configured to prompt a user before performing such actions. For example, in one embodiment, scanner 140 is configured to prompt the user before entering a signature. In this embodiment, scanner 140 may be configured to verify that a particular user (e.g., corresponding to the name on the signature) is actually using the device by recording an image of the user's face and determining that it is the particular user. In this embodiment, scanner 140 may be configured to capture one or more images of a current user and insert a signature of a recognized user of the device. In this embodiment, users may configure scanner 140 to recognize their face before using scanner 140 to perform various other functions. Facial recognition (along with other recognition such as fingerprinting, etc.) may be used in various embodiments to authenticate a user or to determine which user is currently using a device.

Bill 260, in the illustrated embodiment, includes a payee, an amount due ($150), and a due date (Mar. 21, 2015). Bills may include various additional information such as type of good or service, etc. In one embodiment, scanner 140 is configured to determine that a document is a bill, e.g., based on a financial application running on a device. In one embodiment, scanner 140 is configured to connect to a bank account and transfer the correct amount to a vendor to pay the bill based on the amount due. In another embodiment, scanner 140 is configured to print a check for a user with the correct amount to pay the bill. In one embodiment, scanner 140 is configured to track due dates for bills and notify a user when a bill is nearly due or is late. In one embodiment, scanner 140 is configured to send bill information to a financial program such as QUICKBOOKS® or QUICKEN®, for example.

In some embodiments, applications may be associated with multiple types of information. For example, financial applications may be associated with both bills and receipts. In one embodiment, scanner 140 is configured to predict multiple information types and scan an image for those information types. In this embodiment, scanner 140 may determine a desired type of information based on extracted information from the image matching one of the information types.

Image 270, in the illustrated embodiment, is a photograph of a computer mouse. Image 270 is wrinkled in the illustrated embodiment. In one embodiment, scanner 140 is configured to determine that image information is desired based on a running photo editing application, for example. In one embodiment, scanner 140 is configured to adjust image 270. For example, scanner 140 may be configured to correct skew, tilt, adjust for folds in the paper, etc. to produce a corrected digital copy before displaying the image to the user or importing the image into a photo application. In some embodiments, scanner 140 may be configured to perform edge analysis, rotation, quality and lighting adjustments, etc. In one embodiment, scanner 140 is configured to combine multiple photographs of an image in order to create a composite image that is sharper than a single photograph of the image.

In some embodiments, scanner 140 may be configured to request confirmation from a user that scanning the photo is desired before displaying the photo or importing it into a photo editing program.

In some embodiments, users may create new information types for scanner 140 and upload them to a database to share with other users. For example, an application developer may create a new information type and upload characteristics of the information type so that it can be used by other applications to indicate that they are associated with the type of information. Information types may be associated data formats, actions to be taken by scanner 140, and/or characteristics of objects associated with the information types, for example.

In some embodiments, scanner 140 may be configured to extract different information in different contexts. For example, consider an image that includes multiple objects from FIG. 2. In one embodiment, scanner 140 is not configured to extract all of the information from the multiple objects. Rather, scanner 140 is configured to predict a desired information type and extract only information of the desired information type from the image. In this embodiment, scanner 140 may extract different information when different applications are running on device 100. For example, in a first situation in which a merchant website is currently displayed on device 100, scanner 140 may be configured to extract payment information, while in a second situation in which a drawing application is displayed, scanner 140 may be configured to extract drawing information from the same image. This may reduce processing time and allow scanner 140 provide information to a user quickly, in comparison to extracting all information in an image.

### Identification

As discussed above with reference to signature fields, in some embodiments, scanner 140 is configured to determine identification information based on image data. In one embodiment, scanner 140 is configured to determine identification information from a fingerprint in an image. In another embodiment, scanner 140 is configured to determine identification information based on a face in an image or a sequence of images. Scanner 140 may be configured to indicate to other applications that authentication was successful using messages defined by an API, for example. Scanner 140 may also be configured to indicate the identity of a known user based on such authentication. In some embodiments, such authentication may be used to login to a device or website, sign a document, verify a sender of a message, confirm various actions, etc. In one embodiment, device 100 includes multiple cameras, including one facing a user viewing a display of device 100. In this embodiment, scanner 140 may be configured to automatically capture image data using the front-facing camera in response to determining that identification is desired and automatically authenticate or deny authentication based on face recognition, for example.

In one embodiment, a user may capture one or more images of another individual and scanner 140 is configured to identify the other person by comparing the images to stored image information corresponding to the user's contacts. For example, the user may recognize a business contact, but be unable to remember their name. Such a user may surreptitiously snap a photo of the person and scanner 140 may be configured to identify the person so that the user can greet them by name. In one embodiment, in response to detecting a face in an image, scanner 140 is configured to prompt the user to determine if the user desires this function to be performed.

Referring now to FIG. 3A, a flow diagram illustrating one exemplary embodiment of a method 300 for extracting information from an image is shown. The method shown in FIG. 3A may be used in conjunction with any of the computer systems, devices, elements, or components disclosed herein, among other devices. In various embodiments, some of the method elements shown may be performed concurrently, in a different order than shown, or may be omitted. Additional method elements may also be performed as desired. Flow begins at block 310.

At block 310, scanner 140 is triggered. Various embodiments for triggering scanner 140 are described below with reference to FIG. 3C. In one embodiment, scanner 140 is always running, and step 310 indicates that scanner 140 should initiate image capture. In one embodiment, step 310 indicates that scanner 140 should begin execution. In various embodiments, step 310 may indicate that scanner 140 should determine a desired information type. Flow proceeds to decision block 315.

At decision block 315, scanner 140 is configured to determine whether any information types are available (e.g., can be predicted or determined). Various embodiments for determining information types are described below with reference to FIG. 3B. Scanner 140 may be configured to determine a desired information type based on applications running on device 100, user input, and/or an image scan (e.g., step 320, which may be performed before step 315 in some embodiments and/or may be performed multiple times). In other embodiments, scanner 140 may be configured to predict a desired information type based on additional information. In one embodiment, if scanner 140 cannot predict a desired information type, scanner 140 is configured to prompt the user to select an information type. Flow proceeds to block 320.

At block 320, scanner 140 is configured to scan an image. In various embodiments, scanner 140 may be configured to implement any of various techniques for extracting information from image data including recognizing objects, recognizing text characters, scanning barcodes, determining pixel information for a corrected image, etc. In some embodiments, scanner 140 is configured to determine information of the desired image type during scan step 320. In some embodiments, scanner 140 is configured to scan for only objects and information associated with the information type, which may reduce processing time and power consumption. Flow proceeds to block 325.

At block 325, scanner 140 is configured to provide information, e.g., to the user or an application. In one embodiment, scanner 140 is configured to provide the information in a data format associated with the information type and/or with a receiving application. In one embodiment, scanner 140 is configured to prompt a user for confirmation before providing the information to an application. Flow ends at block 325.

### Predicting/Determining Information Types

Referring now to FIG. 3B, a block diagram illustrating exemplary inputs for determining an information type is shown. In the illustrated embodiment, an information type is determined based on applications 330, a coarse image scan 335, and/or user input 340. In other embodiments, the determination of block 345 may be performed based on additional inputs in addition to and/or in place of those shown.

In some embodiments, scanner 140 may be configured to give greater weight to information types indicated by applications that are currently displayed on device 100 or have recently been opened. In some embodiments, scanner 140 may be configured to perform a coarse image scan that detects objects in a set of objects associated with running applications. In one embodiment, the coarse image scan is configured to give greater weight to currently displayed applications or applications that were recently opened. For example, if the coarse image scan detects multiple objects of the set of objects in an image, it may predict an information type associated with an object associated with a currently displayed or recently opened application instead of another object in the image. In some embodiments, scanner 140 is configured to determine a desired information type without explicit user input indicated the information type. In one embodiment, scanner 140 is configured to present a selected set of information types (e.g., those associated with a currently displayed application) to the user, allowing the user to select a desired information type.

In some embodiments, scanner 140 may be configured to use a heuristic to predict a desired information type, and may prompt a user for input to confirm that the prediction was correct before sending or displaying extracted information. In these embodiments, scanner 140 may be configured to give greater weights to various indications in predicting a desired information type, as described throughout this disclosure. FIG. 5, described below, illustrates examples of predicting or determining information types based on running applications and/or coarse image scanning.

### Triggering the Scanner

Referring now to FIG. 3C, a block diagram illustrating exemplary inputs for triggering scanner 140 is shown. In the illustrated embodiment, the scanner is triggered based on one or more of user input 350, motion 355, a particular application 360, and/or a major image change 365. In other embodiments, the triggering of block 370 may be performed based on other inputs in addition to and/or in place of those shown.

In various embodiments, a user may select an icon, perform a gesture, speak a command, or otherwise input to device 100 an indication of a desire to trigger scanner 140. In some embodiments, the user input does not explicitly indicate a desired type of information, but simply that a scan is desired. As discussed elsewhere in this disclosure, scanner 140 may be configured to predict an information type and extract information from a captured image. In some embodiments, the user input may also trigger capture of one or more images by camera 110 for scanning by scanner 140.

In one embodiment, scanner 140 may be triggered by motion of device 100. For example, a user may hold up device 100 to point a camera of device 100 at an object to be scanned. In some embodiments, device 100 may be configured to detect motion using one or more accelerometers and/or gyroscopes, for example. Based on detecting a particular type of motion, device 100 may be configured to trigger scanner 140. Any of various appropriates motions may be used to trigger scanner 140. In one embodiment, a user may program scanner 140 to be triggered by particular movements, e.g., by recording the movements to configure scanner 140.

In one embodiment, scanner 140 may be triggered by a particular application. For example, scanner 140 may be configured to determine an information type in response to opening of a particular application. In another embodiment, an application may send an explicit indication of a desired information type to scanner 140, and scanner 140 may be configured to trigger image capture and extract information of the desired type in response to the explicit indication. For example, an application may determine that payment information is needed and ask scanner 140 for payment information. Scanner 140 may then trigger camera 110 to capture images and extract credit card information from the images. This may allow various different types of applications to use scanner 140 to extract information from images without including image capturing modules in each application.

In one embodiment, scanner 140 may be triggered by major changes in captured images. In one embodiment, device 100 is configured to continuously or periodically capture image data using camera 110 and indicate to scanner 140 when a major change in the image occurs (e.g., as caused by a user holding up an object to the camera). In response to this indication, in one embodiment, scanner 140 is configured to predict a desired information type. In another embodiment, device 100 is not configured to continuously or periodically capture image data, but may begin to capture image data when a new application is opened and may only trigger scanner 140 if a change in image data is detected after opening of the application. For example, a user may open an image editing program, which may cause device 100 to begin capturing image data (scanner 140 may be configured to initiate this image capture). Subsequently, the user may hold a photograph up to camera 110, causing a major change in images captured by the camera, which may trigger scanner 140 to predict or determine a desired information type, in this embodiment.

Referring now to FIG. 4, a flow diagram illustrating one exemplary embodiment of a method 400 for extracting information from an image is shown. The method shown in FIG. 4 may be used in conjunction with any of the computer systems, devices, elements, or components disclosed herein, among other devices. In various embodiments, some of the method elements shown may be performed concurrently, in a different order than shown, or may be omitted. Additional method elements may also be performed as desired. Flow begins at block 410.

At block 410, an image is received from a camera in a computing device. In some embodiments, the image may be part of a two-dimensional or three-dimensional video. Flow proceeds to block 420.

At block 420, a type of information included in the image is predicted. In some embodiments, scanner 140 is configured to predict a type of information based on applications running on the computing device and/or a coarse scan of the image to detect objects associated with applications running on the computing device. Flow proceeds to block 430.

At block 430, information extracted from the image is provided to one or more applications running on the computing device. In this embodiment, the information is extracted by the computing device performing a scan of the image based on the predicted type of information. For example, the device 100 and/or scanner 140 may be configured to perform different types of scans depending on if the information type corresponds to text information, drawing information, or image information. As another example, the device 100 and/or scanner 140 may be configured to perform different types of scans depending on a type of object associated with the predicted type of information (e.g., a credit card as opposed to a sheet of paper or a finger/face for authentication). Flow ends at block 430.

Referring now to FIG. 5, a block diagram illustrates exemplary information types and objects associated with applications. The illustrated table shows four exemplary applications: an image editing application, a financial application, a drawing application, and a payment application. In other embodiments, other applications, information types, and/or objects may be processed by scanner 140 in addition to and/or in place of those shown.

Consider an exemplary situation in which only the payment application is running on device 100. In one embodiment, in this situation, scanner 100 is configured to determine that financial information is desired and scan an image for financial information on credit card objects. In this embodiment, scanner 140 may make the determination without a course image scan, based only on running applications.

Consider another exemplary situation in which both the image editing application and the payment application are running on device 100. In one embodiment, in this situation, scanner 140 is configured to perform a coarse image scan to determine whether photographs or credit cards (objects in a set of objects associated with running applications) are detected in an image. In this embodiment, based on detecting either a photograph or a credit card, scanner 140 is configured to predict the information type associated with the object. This may allow a user to scan a photograph, for example, by simply holding a photograph in from of camera 110 even when both a payment application and an image editing application are running.

In this embodiment, if both a photograph and a credit card were detected in an image, scanner 140 may be configured to predict a desired information type based on whether the image editing application or the payment application is currently displayed or recently opened. For example, if the user has just launched the payment application of a payment screen within an application (e.g., a payment screen in a web browser), scanner 140 may be configured to predict a payment information type rather than an image information type, even though an image object may be detected by the coarse image scan.

Similar techniques may be implemented for the other applications shown (e.g., financial and drawing). For example, scanner 140 may be configured to select between a drawing application and an image application based on whether the drawing application or the image application is currently displayed or recently opened. Further, scanner 140 may be configured to select between a drawing application and an image application based on whether a detected object appears to be a drawing (e.g., with well-defined lines) or a photograph. As yet another example, if both a financial application and a drawing application are currently running, scanner 140 may be configured to determine either a financial information type or a drawing information type based on whether a receipt object or a drawing object is detected, e.g., based on whether the object such as a sheet of paper includes text.

In various embodiments, scanner 140 may be configured to maintain a list or database of applications with associated information types and objects. In some embodiments, one or more API's may be used to indicate associations between applications and information types and objects to scanner 140. In some embodiments, an application may be associated with an information type at one point in time and not associated with the information type at another point in time. For example, scanner 140 may be configured to associate a web browser application with a payment information type when the browser is displaying a payment screen, but not when the browser is displaying another type of webpage. In one embodiment, scanner 140 may analyze data in webpages displayed by a browser to determine information types associated with the webpages (e.g., by detecting payment fields). In another embodiment, a browser application may indicate to scanner 140 what information types it is currently associated with.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
receiving an image from a camera in a computing device;
predicting a type of information included in the image;
providing information extracted from the image to one or more applications running on the computing device, wherein the information is extracted by the computing device performing a scan of the image based on the predicted type of information.

2. The method of claim 1, wherein the predicting is based on a determination that at least one application running on the computing device is associated with the type of information.

3. The method of claim 2, further comprising determining that an application is associated with the type of information based on receiving an indication from an application that it utilizes the type of information.

4. The method of claim 2, further comprising determining that an application is associated with the type of information based on a list of applications previously determined to utilize the type of information.

5. The method of claim 1, wherein the predicting is based on a determination that a currently displayed application on the computing device utilizes the type of information.

6. The method of claim 1, wherein the predicting includes selecting the type of information from among a plurality of types of information associated with applications available on the computing device.

7. The method of claim 6, wherein the predicting includes scoring applications of the plurality of applications differently based on whether the applications are currently displayed on the computing device.

8. The method of claim 1, wherein the predicting is based on a determination that a recently opened application utilizes the type of information.

9. The method of claim 1, further comprising:
maintaining object information indicating objects that include information types associated with a plurality of applications available on the computing device,
wherein the predicting is based on detecting an object in the image that is in a set of objects indicated by the object information to include information types associated applications running on the computing device, wherein the detecting includes searching for only objects in the image that are in the set of objects.

10. The method of claim 1, further comprising selecting a data format for providing the information based on the predicted type of information.

11. A non-transitory computer-readable storage medium having instructions stored thereon that are executable by a computing device to perform operations comprising:
receiving an image from a camera of a computing device;
predicting a type of information included in the image without user input specifying the type of information; and
providing information of the type of information to one or more applications running on the computing device, wherein the information is extracted by the computing device performing a scan of the image.

12. The non-transitory computer-readable storage medium of claim 11, wherein the predicting is based on a determination that at least one application running on the computing device is associated with the type of information.

13. The non-transitory computer-readable storage medium of claim 12, wherein the predicting is further based on a determination that a currently displayed application is associated with the type of information.

14. The non-transitory computer-readable storage medium of claim 13, wherein the predicting includes selecting the type of information instead of a second, different type of information that is associated with an application that is not currently displayed.

15. The non-transitory computer-readable storage medium of claim 11,
wherein the predicting is based on detecting an object in the image that includes the type of information;
wherein the detecting the object includes scanning for objects in the image in a set of objects indicated by one or more applications running on the computing device.

16. The non-transitory computer-readable storage medium of claim 11, wherein the predicting includes:
selecting a type of information from among a plurality of types of information associated with applications available on the computing device; and
scoring applications differently based on whether the applications are recently-opened on the computing device and whether the applications are currently displayed on the computing device.

17. The non-transitory computer-readable storage medium of claim 11, wherein the operations further comprise:
initiating the predicting in response to a trigger selected from the group consisting of:
motion of the computing device;
initiation of a particular application on the computing device; and
a major change in images captured by the computing device.

18. The non-transitory computer-readable storage medium of claim 11, wherein the operations further comprise determining that an application is associated with the type of information based on an indication from the application or based on a stored set of applications associated with the type of information.

19. The non-transitory computer-readable storage medium of claim 11, wherein the operations further comprise:
generating a composite image from a plurality of images received from the camera;
wherein the information is extracted by the computing device performing a scan of the composite image.

20. An apparatus, comprising:
a camera;
one or more memories storing program instructions and configured to store image data captured by the camera; and
one or more processors configured execute the program instructions to:
execute one or more applications;
automatically predict a type of information included in an image without user input indicating the type of information;
extract information from the image based on the predicted type of information; and
provide the information to an application running on the computing device.

21. The apparatus of claim 20, wherein the apparatus is configured to predict the type of information based on an indication that one or more applications running on the apparatus operate using the type of information.
